(19) United States
(12) Patent Application Publication
(10) Pub. No.: US 2022/0181654 A1
(43) Pub. Date: Jun. 9, 2022

(54) CONVEYOR UNIT FOR A FUEL CELL SYSTEM FOR CONVEYING AND/OR CONTROLLING A GASEOUS MEDIUM

(71) Applicant: Robert Bosch GmbH, Stuttgart (DE)

(72) Inventor: Armin Richter, Leinfelden-Echterdinge (DE)

(21) Appl. No.: 17/601,161

(22) PCT Filed: Mar. 11, 2020
(86) PCT No.: PCT/EP2020/056422

§ 371 Date: Oct. 4, 2021

(30) Foreign Application Priority Data
Apr. 3, 2019 (DE) 10 2019 204 723.8

(51) Int. Cl. H01M 8/04089; H01M 8/04746

(52) U.S. Cl. CPC H01M 8/04097; H01M 2250/20; H01M 8/04753

(57) ABSTRACT

The invention relates to a conveyor unit (1) for a fuel cell system (31) for conveying and/or controlling a gaseous medium, in particular hydrogen, comprising a jet pump (4), which is driven by a propulsion jet of a pressurized gaseous medium, and a metering valve (6), an outlet of the conveyor unit (1) being fluidically connected to an anode inlet (15) of a fuel cell (29). The jet pump (4) has a suction region (7), a mixing tube (18), and a diffuser (20), wherein the diffuser (20) is at least indirectly fluidically connected to the anode inlet (15) of the fuel cell (29), and the gaseous medium flows through the jet pump (4) at least partly in the direction of a first flow direction (V) which runs parallel to a first longitudinal axis (39) of the mixing tube (18). According to the invention, a second longitudinal axis (40) of the diffuser (20) is curved or inclined relative to the first longitudinal axis (39) of the mixing tube (18).

### BACKGROUND OF THE INVENTION

The present invention relates to a conveyor unit for a fuel cell system for conveying and/or controlling a gaseous medium, in particular hydrogen, which is provided in particular for use in vehicles with a fuel cell drive.

In addition to liquid fuels, gaseous fuels will also play an increasing role in the vehicle sector in the future. Particularly in vehicles with fuel cell drives, there is a need to control hydrogen gas flows. In this case, the gas flows are no longer controlled discontinuously, as in the case of the injection of liquid fuel, but rather the gas is taken from at least one tank, in particular a high-pressure tank, and passed via an inflow line of a medium-pressure line system to the conveyor unit. This conveyor unit passes the gas via a connecting line of a low-pressure line system to a fuel cell.

DE 10 2014 221 506 A1 discloses a conveyor unit for a fuel cell system for conveying a gaseous medium, in particular hydrogen, having a jet pump, which is driven by a propulsion jet of a pressurized gaseous medium, and a metering valve. In this case, the conveyor unit can be embodied as a combined valve-jet pump arrangement and has the components first inlet, intake region, mixing tube and a diffuser, and wherein the diffuser is fluidically connected to an anode inlet of a fuel cell via an outlet elbow. In this case, a connecting piece can optionally be located between the outlet elbow and the anode inlet. In this case, a medium, in particular a working medium, can be discharged through a nozzle by means of the conveyor unit, and is then mixed with a recirculation medium. Here, the flow of the working medium can be controlled by means of the metering valve. In order for the gaseous medium to be able to flow into the anode inlet of the fuel cell after flowing through the valve-jet pump arrangement, a deflection must take place on account of the arrangement of the valve-jet pump arrangement on the fuel cell. From the conveyor unit known from DE 10 2014 221 506 A1, this deflection takes place at least virtually exclusively in the region of the outlet elbow, the deflection taking place at least approximately at right angles and/or through at least approximately 90° so that the gaseous medium can flow from the conveyor unit into the fuel cell.

The conveyor unit known from DE 10 2014 221 506 A1 can have certain disadvantages.

Since the deflection of the gaseous medium in the region of the conveyor unit takes place at least virtually exclusively in the region of the outlet elbow, an at least approximately right-angled deflection must take place exclusively in this region, in particular through at least approximately 90°. In this case, a first flow direction of the mixing tube and/or a second flow direction of the diffuser runs at least approximately at right angles to a second flow path of the anode inlet of the fuel cell, the second flow path forming, in particular, the inflow direction of the gaseous medium into the fuel cell. This leads to high flow losses and/or frictional losses and/or pressure losses between the gaseous medium and the walls of the conveyor unit, particularly in the region of the outlet elbow, owing to the short length available in the direction of a first longitudinal axis of the jet pump to bring about the deflection of the gaseous medium. Moreover, in the conveyor unit shown in the prior art, particularly in the flow region of the outlet elbow, turbulence and/or flow separations that are disadvantageous for the efficiency of the conveyor unit and/or of the fuel cell system may occur. As a result, the efficiency of the conveyor unit and/or of the entire fuel cell system are/is reduced.

### SUMMARY OF THE INVENTION

According to the invention, a conveyor unit for a fuel cell system is proposed for conveying and/or recirculating a gaseous medium, in particular hydrogen, the hydrogen being referred to below as H₂.

According to the invention, a second longitudinal axis of a diffuser is curved or is inclined relative to the first longitudinal axis of a mixing tube. In this way, it is possible to achieve the advantage that the deflection of the gaseous medium in the region of the conveyor unit no longer takes place exclusively in the region of an outlet elbow, but that there is already an at least partial deflection of the gaseous medium in the region of the diffuser, said deflection reducing the angle of the necessary flow deflection in the region of the outlet elbow. In this way, a deflection of the gaseous medium in the region of the conveyor unit, in particular of the diffuser and/or of the outlet elbow, can be achieved over a longer flow path and/or by means of a smaller deflection over a flow path with a specific length. In this case, flow losses and/or frictional losses and/or pressure losses between the gaseous medium and the walls of the conveyor unit can be reduced since the deflection takes place in a more favorable way in terms of flow and friction of the gaseous medium with the wall of the conveyor unit is reduced. Moreover, in the region of a connecting piece of the conveyor unit and/or of an anode inlet of a fuel cell, there are/is reduced disadvantageous turbulence and/or flow separations since deflection takes place more uniformly and in interaction with an increasing diameter in the region of the diffuser, thereby making it possible to avoid disadvantageous flow changes, for example due to locally severe changes in the flow speed. In this case, the flow speed of the gaseous medium in the diffuser is reduced, while the medium simultaneously undergoes a deflection, thereby making it possible to bring about improved inflow behavior into the fuel cell. In this way, it is possible to achieve the advantage that losses of energy of momentum, kinetic energy and pressure are virtually avoided or at least reduced. Furthermore, owing to the improved deflection, as little friction as possible can be achieved between the medium to be conveyed, in particular H₂, and the surface of the flow geometry of the conveyor unit, in particular of the end region of the diffuser and of the outlet elbow. Furthermore, pressure losses and/or frictional losses that may occur on account of the flow deflections and/or changes in the directions of movement of the gaseous medium due to the deflection in the outlet elbow can be reduced. In this way, the efficiency of the conveyor unit and/or of a valve-jet pump arrangement and/or of the entire fuel cell system can be improved. Moreover, it is possible to achieve the advantage by means of the configuration according to the invention of the conveyor unit that, given a predetermined overall structural length, owing to the available installation space in the overall vehicle for example, it is possible to achieve a larger deflection radius, thereby allowing a further reduction in the flow energy losses in the conveyor unit due to friction of the gaseous medium with the surface of the flow geometry. This offers the advantage of a high efficiency of the conveyor unit with a simultaneous compact design of the conveyor unit.

According to an advantageous development of the conveyor unit, a first wall of the diffuser runs at least partially parallel to the first longitudinal axis of the mixing tube, and a second wall of the diffuser, which is located opposite the first wall, runs at an angle to the first longitudinal axis of the mixing tube, wherein the first wall runs on that side of the diffuser which is further away from the anode inlet, and the second wall runs on that side of the diffuser which is closer to the anode inlet. In this way, it is possible to form a diffuser of a kind which simultaneously permits a deflection of the gaseous medium. Thus, integration of a deflection region into the diffuser is achieved, thereby making it possible to bring about a more compact design of the conveyor unit. Moreover, simplified and less expensive production of a flow region can be achieved by means of the first wall running parallel to the mixing tube.

According to a particularly advantageous development, the first wall of the diffuser has a curved profile, wherein the second wall of the diffuser, which is located opposite the first wall, has an at least approximately linear profile and runs at an angle to the first longitudinal axis of the mixing tube. In this way, a continuously increasing deflection of the gaseous medium in a second flow direction can be achieved, wherein, in particular, a second flow axis is arc-shaped. On account of the curved profile of the second wall, flow losses and/or frictional losses and/or pressure losses can be prevented since, for example, in the case of a linear profile of the second wall with a deflecting edge, turbulence and/or flow separations can occur. Thus, the efficiency of the conveyor unit and/or of the entire fuel cell system can be increased. Furthermore, energy losses which can occur in the event of increased friction of the gaseous medium with the wall of the flow region can be reduced by means of the configuration according to the invention of the conveyor unit. In this way, the operating costs of the conveyor unit and/or of the fuel cell system can be reduced, since a higher efficiency can be achieved.

According to a particularly advantageous embodiment of the conveyor unit, the second longitudinal axis of the diffuser is inclined in the direction of the anode inlet. In this way, it is possible to achieve the advantage that the angle of the third flow direction in the outlet elbow can be reduced since the gaseous medium is already at least partially deflected in the inflow direction of the anode inlet in the region of the diffuser. In this case, the flow resistance of the conveyor unit, which, in particular, is mounted on an end plate of the fuel cell, is reduced owing to the necessary flow deflection of the gaseous medium in the conveyor unit since, owing to the inclined second longitudinal axis of the diffuser, the gaseous medium is already deflected in the region in which it undergoes a reduction in flow speed. Thus, in the region of the outlet elbow, only a relatively small deflection of the gaseous medium has to take place since at least a partial deflection in the same direction has already taken place in the region of the diffuser. In this case, the flow resistance of the conveyor unit to the necessary and approximately right-angled deflection of the gaseous medium can be reduced, thereby making it possible to improve a jet pump effect of the conveyor unit and enabling the medium to flow into the fuel cell at a higher speed and/or a higher pressure and/or a higher mass flow.

According to an advantageous embodiment of the conveyor unit, the second longitudinal axis of the diffuser runs in an arc shape in such a way that, in the initial region of the diffuser, it runs at least approximately parallel to the first longitudinal axis of the mixing tube, and, in the end region of the diffuser, it runs at least approximately perpendicular to the first longitudinal axis of the mixing tube. In this way, it is possible, on the one hand, to achieve a flow-optimized deflection through at least approximately a right angle, wherein the two flow directions run at least approximately orthogonally to one another. By avoiding edge-like diversions and/or by means of the configuration according to the invention of the initial region and of the end region of the diffuser, it is possible to achieve a reduction in turbulence and flow separations during the inflow and outflow of the gaseous medium into and out of the diffuser since abrupt changes in direction of the flow are prevented in this region. Thus, on account of the deflection and/or change in the flow directions of the gaseous medium due to the arc-shaped second longitudinal axis of the diffuser, pressure losses and frictional losses can be reduced, thereby making it possible to improve the efficiency of the conveyor unit and/or of the valve-jet pump arrangement and/or of the entire fuel cell system.

According to an advantageous development of the conveyor unit, the connecting piece and/or the outlet elbow are/is located between the diffuser and the anode inlet of the fuel cell and connect/s these at least indirectly fluidically to one another. Moreover, a fourth longitudinal axis of the connecting piece can run parallel to the flow path IV of the gaseous medium in the anode inlet, wherein the second longitudinal axis of the diffuser runs at least approximately parallel to the fourth longitudinal axis of the connecting piece in the end region of the diffuser. In this way, an acceleration and/or deceleration of the gaseous medium can be prevented, wherein this acceleration and/or deceleration can occur, for example, when using an external piping system between the conveyor unit and the fuel cell, in particular the anode inlet, with a plurality of deflections. This can prevent energy from being withdrawn from the gaseous medium, which energy is lost to the gaseous medium as it flows through an external piping system with deflections on account of internal and external friction. In this way, it is possible to achieve the advantage that losses of energy of momentum, kinetic energy and pressure are virtually avoided or at least reduced. Moreover, in this way, particularly on account of the flow-optimized design of the connecting piece and/or of the outlet elbow, as little friction as possible can be achieved between the medium to be conveyed, in particular H₂, and the surface of the flow geometry of the conveyor unit. Furthermore, pressure losses and/or frictional losses that may occur on account of the flow deflections and/or changes in the directions of movement of the gaseous medium due to the deflection in the external piping system can be reduced. In this way, the efficiency of the conveyor unit and/or of the valve-jet pump arrangement and/or of the entire fuel cell system can be improved. Furthermore, it is possible in this way to achieve the advantage that the flow connection between a jet pump and the anode inlet can be made as short as possible and/or at least virtually without flow deflection. Thus, the efficiency of the conveyor unit and thus of the entire fuel cell system can be increased on account of the reduced frictional losses. Furthermore, when the connecting piece is integrated into a main body of the jet pump, an improved cold start capability of the conveyor unit can be achieved since the connecting piece thus cools more slowly, in particular on account of the larger dimensions, and therefore the formation of ice bridges in the flow cross section is made more difficult, particularly with short stoppage times.

According to an advantageous embodiment of the conveyor unit, the jet pump has a heating element, wherein the jet pump and/or the outlet elbow and/or the connecting piece are/is produced from a material or an alloy with a low specific heat capacity. In this way, it is possible to achieve the advantage that rapid heating of the conveyor unit according to the invention can be achieved, in particular within the framework of a cold start procedure. Before the conveyor unit and/or the entire fuel cell system is put into operation at low temperatures, the heating element is supplied with energy, in particular electrical energy, wherein the heating element converts this energy into heat and/or heating energy. This process is advantageously supported by the low specific heat capacity of the other components of the conveyor unit, by means of which the heat energy can rapidly penetrate into the entire conveyor unit and can eliminate existing ice bridges. As a result of the faster heating of the parts and of the conveyor unit, existing ice bridges can be eliminated more quickly, in particular by melting through the introduction of heat. Moreover, during a cold start process, the heating energy can penetrate to a nozzle in a short time after the heating element is switched on, and existing ice bridges in the region of the nozzle and the actuator system of a metering valve can be heated and thus eliminated. In this way, the probability of failure due to damage to the components of the conveyor unit can be reduced. In this way, the cold start capability of the conveyor unit and thus of the entire fuel cell system can be improved since the ice bridges can be thawed and eliminated more quickly. In addition, less energy, in particular electrical energy and/or heat energy, has to be introduced into the conveyor unit by the heating element used. It is thereby possible to reduce the operating costs of the conveyor unit and of the entire fuel cell system, particularly in the case of frequent cold start processes due to low ambient temperatures and/or long stoppage times of the vehicle. Furthermore, the use of the material according to the invention also makes it possible to achieve high resistance to the medium to be conveyed by the conveyor unit and/or other constituents from the environment of the conveyor unit, such as, for example, chemicals. This, in turn, increases the service life of the conveyor unit, and the probability of failure due to material damage to the housing can be reduced.

According to a particularly advantageous development of the conveyor unit, the latter has, as components, a jet pump, the metering valve and/or a side-channel compressor and/or a water separator. The conveyor unit and/or its components are positioned on the end plate of the fuel cell in such a way that the flow lines between and/or within the components of the conveyor unit run exclusively parallel to the end plate, wherein the end plate is arranged between the fuel cell and the conveyor unit. In this way, a compact arrangement of the conveyor unit on the fuel cell and/or in the fuel cell system can be brought about, thereby making it possible to reduce the space requirement and the installation space of the fuel cell system in the overall vehicle.

Moreover, it is possible in this way to produce a direct flow line, which is as short as possible, between the components of the conveyor device and the fuel cell. Furthermore, the number of flow deflections and/or changes in the directions of movement of the gaseous medium in the conveyor unit can be reduced to the lowest possible number. This offers the advantage that the flow losses and/or pressure losses within the conveyor unit due to the length of the flow lines and/or the number of flow deflections can be reduced. It is furthermore also advantageous that the flow lines between and/or within the components of the conveyor unit run parallel to the plate-shaped carrier element. Thus, a flow deflection of the gaseous medium is further reduced, thereby making it possible to further reduce the flow losses. As a result, the efficiency of the conveyor unit can be improved and the energy consumption for operating the conveyor device can be reduced. Moreover, it is possible in this way to achieve the advantage that simple positioning of the components relative to one another can be achieved in that the components each have to be connected to the end plate. It is thereby possible to reduce the number of components required for assembly, which in turn leads to cost savings for the conveying device. Furthermore, the probability of an assembly error due to incorrectly aligned components of the conveying device is reduced, which in turn reduces the probability of failure of the conveyor unit during operation.

The invention is not restricted to the illustrative embodiments described here or to the aspects emphasized herein. On the contrary, a large number of modifications and/or combinations of the features and/or advantages described in the claims that lie within the scope of action of a person skilled in the art is possible within the range indicated by the claims.

### BRIEF DESCRIPTION OF THE DRAWINGS

The invention is described in greater detail below with reference to the drawing.

In the drawing:

FIG. 1 shows a partially schematic sectional view of a fuel cell system with a conveyor unit and a fuel cell,

FIG. 2 shows a schematic sectional view of the conveyor unit according to a first exemplary embodiment,

FIG. 3 shows a schematic sectional view of the conveyor unit according to a second exemplary embodiment,

FIG. 4 shows a schematic sectional view of the at least one cross-sectional area A-A running orthogonally to a direction of flow in accordance with a first embodiment,

FIG. 5 shows a schematic sectional view of the at least one cross-sectional area A-A running orthogonally to the flow direction in accordance with a second embodiment.

### DETAILED DESCRIPTION

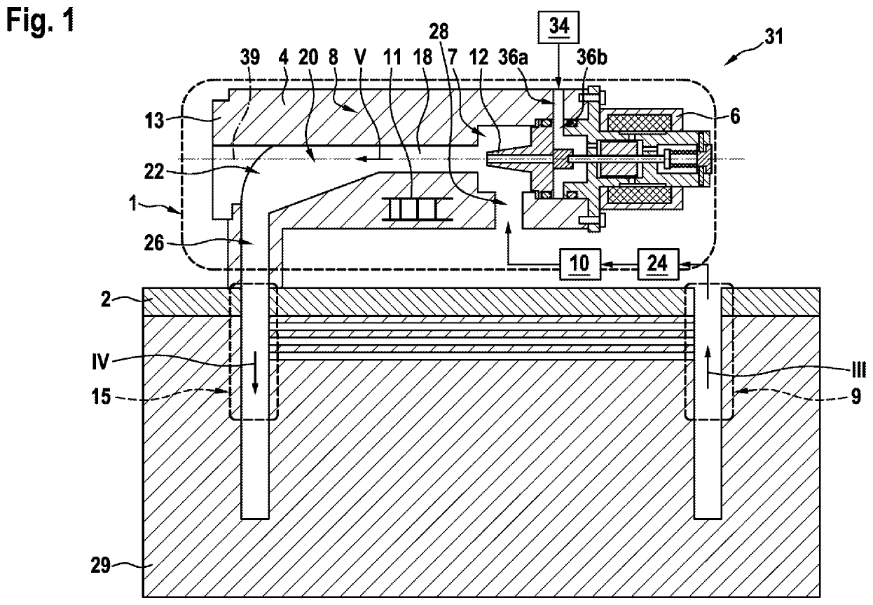

The illustration according to FIG. 1 shows a schematic sectional view of a fuel cell system 31 with a conveyor unit 1, wherein the conveyor unit 1 has a combined valve-jet pump arrangement 8. The combined valve-jet pump arrangement 8 has a metering valve 6 and a jet pump 4, wherein the metering valve 6 is connected, e.g. by means of a screw connection, to the jet pump 4, in particular to a main body 13 of the jet pump 4.

In this case, the jet pump 4 has in its main body 13 a first inlet 28, a second inlet 36a, an intake region 7, a mixing tube 18, a diffuser 20 and an outlet elbow 22 and/or a connecting piece 26. The metering valve 6 has a second inlet 36b and a nozzle 12. In this case, the metering valve 6 is pushed into the jet pump 4, in particular into an opening in the main body 13 of the jet pump 4, in particular in the direction of a first longitudinal axis 39, in particular of the mixing tube 18.

The fuel cell system 31 shown in FIG. 1 furthermore has the components fuel cell 29, water separator 24 and side-channel compressor 10. In this case, the fuel cell 29 is connected at least indirectly fluidically to the water separator 24 and/or the side channel compressor 10 and/or the valve-jet pump arrangement 8 by means of an anode outlet 9 and/or an anode inlet 15. In this arrangement, the recirculation medium flows out of the fuel cell 29 through the anode outlet 9 in the direction of a first flow path III and, in particular, after flowing through further optional components 10, 24 and/or the valve-jet pump arrangement 8, back into the fuel cell 29 via the anode inlet 15 in the direction of a second flow path IV. Here, the first flow path III and the second flow path IV run at least approximately parallel. In this case, the components water separator 24 and/or the side-channel compressor 10 and/or the valve-jet pump arrangement 8 are connected at least indirectly fluidically to one another. The components water separator 24 and side-channel compressor 10 are optional components which do not necessarily have to be present in the conveyor unit 1 and/or in the fuel cell system 31. Furthermore, the fuel cell 29 has an end plate 2, wherein the anode outlet 9 and the anode inlet 15 run through the end plate 2. In this case, the end plate 2 is located on the side of the fuel cell 29 facing the valve-jet pump arrangement 8. Here, the components jet pump 4, metering valve 6 and/or side-channel compressor 10 and/or the water separator 24 are positioned on the end plate 2 of the fuel cell 29 in such a way that the flow lines between and/or within the components of the conveyor unit 1 run exclusively parallel to the end plate 2, wherein the end plate 2 is arranged between the fuel cell 29 and the conveyor unit 1. In this arrangement, the unused gaseous medium flows from the anode outlet 9 of the fuel cell 29, in particular a stack, in a flow direction III through the end plate 2, via an optional water separator 24 and an optional side-channel compressor 10, into the first inlet 28 of the valve-jet pump arrangement 8. From there, the gaseous medium flows into the intake region 7 and partially into the mixing tube 18 of the jet pump 4. In this case, the water separator 24 has the task of removing from the system water which is produced during operation of the fuel cell 29 and which, together with the gaseous medium, in particular H₂, flows back into the valve-jet pump arrangement 8 through the anode outlet 9. Thus, the water, which can be present in gaseous and/or liquid form, cannot penetrate into the recirculation blower 10 and/or the jet pump 4 and/or the metering valve 6, since it is already separated directly from the gaseous medium by the water separator 24 and is out of the fuel cell system 31 conveying device. In this way, damage to the components of the conveyor unit 1 and/or of the fuel cell system 31, in particular to the moving parts of the components, due to corrosion can be prevented, thereby increasing the life of all the components through which flow takes place.

FIG. 1 furthermore illustrates that a medium to be conveyed flows through the combined valve-jet pump arrangement 8 in at least one flow direction V, VI, VII, VIII. Here, the majority of the regions of the valve jet pump arrangement 8 through which flow occurs are of at least approximately tubular design and serve to convey and/or guide the gaseous medium, which is, in particular, H₂, in the conveyor unit 1. In this case, on the one hand, a recirculated fluid is fed to the valve-jet pump arrangement 8 through the first inlet 28, the recirculated fluid being, in particular, the unused H₂ from the anode region of the fuel cell 29, in particular a stack, although it is also possible for the recirculated fluid to contain water and nitrogen. In this arrangement, the recirculated fluid flows through the first inlet 28 into the valve-jet pump arrangement 8. On the other hand, a gaseous working medium, in particular H₂, flows through the second inlet 36 from outside the valve-jet pump arrangement 8 into a recess in the valve-jet pump arrangement 8 and/or into the main body 13 and/or the metering valve 6, wherein the working medium comes from a tank 34 and is under high pressure, in particular of more than 6 bar.

In this case, the second inlet 36a, b runs through the components comprising the main body 13 and/or the metering valve 6. From the metering valve 6, the working medium is discharged by means of an actuator system and a completely closable valve element, in particular intermittently, through the nozzle 12 into the intake region 7 and/or the mixing chamber 18. The H₂ flowing through the nozzle 12 and serving as the working medium has a pressure difference with respect to the recirculation medium, wherein the recirculation medium flows from the first inlet 28 into the conveyor unit 1, wherein, in particular, the working medium has a higher pressure of at least 6 bar. To ensure that a “jet pump effect” is obtained, the recirculation medium is conveyed with a low pressure and a low mass flow into a central flow region of the conveyor unit 1, for example by using a side-channel compressor 10 connected upstream of the conveyor unit 1. At the same time, the working medium flows with the described pressure difference and a high velocity, which, in particular, can be close to the speed of sound and can thus be below or above it, through the nozzle 12 into the central flow region of the intake region 7 and/or of the mixing tube 18.

In this case, the nozzle 12 has an inner recess in the form of a flow cross section through which the gaseous medium can flow, in particular coming from the metering valve 6 and flowing into the intake region 7 and/or the mixing tube 18. In this case, the working medium impinges on the recirculation medium which is already in the central flow region of the intake region 7 and/or of the mixing tube 18. On account of the high speed and/or pressure difference between the working medium and the recirculation medium, internal friction and turbulence are produced between the media. In this case, a shear stress arises in the boundary layer between the fast working medium and the substantially slower recirculation medium. This stress causes a transfer of momentum, wherein the recirculation medium is accelerated and entrained. Mixing takes place according to the principle of conservation of momentum. During this process, the recirculation medium is accelerated in flow direction V, and a pressure drop occurs for the recirculation medium, as a result of which a suction effect is engendered and thus further recirculation medium is conveyed out of the region of the first inlet 28. This effect can be referred to as a jet pump effect.

By controlling the metered addition of the working medium by means of the metering valve 6, it is possible to regulate a delivery rate of the recirculation medium and to adapt it to the respective requirement of the overall fuel cell system 31, depending on the operating state and operating requirements. In an illustrative operating state of the conveyor unit 1, in which the metering valve 6 is in the closed state, it is possible to prevent the working medium from flowing from the second inlet 36 into the central flow region of the jet pump 4, thus ensuring that the working medium cannot flow further in flow direction VII to the recirculation medium into the intake region 7 and/or the mixing tube 18 and thus that the jet pump effect stops.

Furthermore, the jet pump 4 from FIG. 1 has technical features which additionally improve the jet pump effect and delivery efficiency and/or further improve the cold start process and/or production and assembly costs. In this case, the diffuser component 20 has a conical profile in the region of its internal flow cross section, in particular increasing in size in the first flow direction V and the second flow direction VI. In this arrangement, the nozzle 12 and the mixing tube 18 and/or the diffuser 20 can be coaxial with respect to one another. By means of this shaping of the diffuser component 20, it is possible to produce the advantageous effect that the kinetic energy is converted into pressure energy, thereby making it possible to further increase the possible delivery volume of the conveyor unit 1, thereby making it possible to feed more of the medium to be conveyed, in particular H₂, to the fuel cell 29, thereby making it possible to increase the efficiency of the overall fuel cell system 31.

As shown in FIG. 1, the combined valve-jet pump arrangement 8 has an optional heating element 11, wherein the valve-jet pump arrangement 8 and/or the outlet elbow 22 and/or the connecting piece 26 are/is produced from a material or an alloy with a low specific heat capacity. In this way, the cold start capability can be improved, especially at temperatures below 0° Celsius, since ice bridges present in the flow region of the valve-jet pump arrangement 8 can thus be broken down. In this case, the heating element 11 can be integrated in the main body 13 of the jet pump 4 or can be arranged thereon.

According to the invention, the metering valve 6 can be designed as a proportional valve 6 in order to enable an improved metering function and more exact metering of the working medium into the intake region 7 and/or the mixing tube 18. In order to further improve the flow geometry and the efficiency of the conveyor unit 1, the nozzle 12 and the mixing tube 18 are of rotationally symmetrical design, the nozzle 12 extending coaxially with respect to the mixing tube 18 of the jet pump 4.

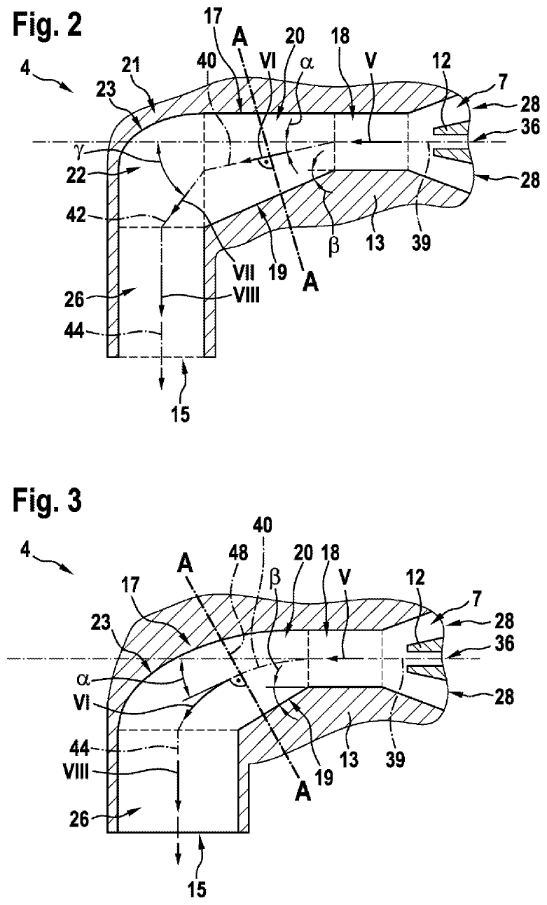

FIG. 2 shows a schematic sectional view of the conveyor unit 1 according to a first exemplary embodiment. In this case, part of the internal flow contour of the conveyor unit 1, in particular of the main body 13, is illustrated, the latter having, in particular in the flow direction of the gaseous medium, the regions of intake region 7, mixing tube 18, diffuser 20, outlet elbow 22 and connecting piece 26. In each case, the mixing tube 18, the diffuser 20, the outlet elbow 22 and the connecting piece 26 have a respective longitudinal axis 39, 40, 42, 44. The respective flow direction V, VI, VII, VIII of the gaseous medium in this region runs along this respective longitudinal axis 39, 40, 42, 44.

It is illustrated that the gaseous medium coming from the intake region 7 flows at least virtually completely through the flow contour of the main body 13 as far as the anode inlet 15 of the fuel cell 29, the gaseous medium flowing through the mixing tube 18, the diffuser 20, the outlet elbow 22 and the connecting piece 26. In the intake region 7, the working medium coming from the second inlet 36 is fed in by means of the nozzle 12 and impinges on the recirculation medium fed in through the first inlet 28, which medium comes, in particular, from the fuel cell 29.

FIG. 2 furthermore shows that the mixing tube 18 has a first longitudinal axis 39, the first flow direction V running at least approximately parallel to the first longitudinal axis 39. The diffuser 20 has a second longitudinal axis 40, wherein the second flow direction VI runs parallel to the second longitudinal axis 40. The outlet elbow 22 has a third longitudinal axis 42, wherein the third flow direction VII runs parallel to the third longitudinal axis 42. The connecting piece 26 has a fourth longitudinal axis 44, wherein the fourth flow direction VIII runs parallel to the fourth longitudinal axis 44. Here, the longitudinal axes 39, 40, 42, 44 and/or flow directions V, VI, VII, VIII in the respective region have different vectors and do not run parallel and/or in the same direction, and therefore the gaseous medium undergoes a deflection in the respective section 18, 20, 22, 26. In this case, the second longitudinal axis 40 of the diffuser 20 is inclined relative to the first longitudinal axis 39 of the mixing tube 18, in particular inclined at an angle α, wherein the second longitudinal axis 40 of the diffuser 20 is inclined in the direction of the anode inlet 15. Furthermore, the third longitudinal axis 42 of the outlet elbow 22 is designed to be inclined to the first longitudinal axis 39 of the mixing tube 18, in particular inclined by an angle γ, wherein the third longitudinal axis 42 of the outlet elbow 22 is inclined in the direction of the anode inlet 15. Moreover, the fourth longitudinal axis 44 of the connecting piece 26 is inclined relative to the first longitudinal axis 39 of the mixing tube 18, in particular inclined at an at least approximately right angle, wherein the fourth flow direction VIII running parallel to the fourth longitudinal axis 44 of the connecting piece 26 is directed toward the anode inlet 15.

FIG. 2 furthermore shows that a first wall 17 of the diffuser 20 runs at least partially parallel to the first longitudinal axis 39 of the mixing tube 18, and a second wall 19 of the diffuser 20, which is located opposite the first wall 17, runs at an angle ß to the first longitudinal axis 39, wherein the first wall 17 runs on that side of the diffuser 20 which is further away from the anode inlet 15, and the second wall 19 runs on that side of the diffuser 20 which is closer to the anode inlet 15. In this case, the gaseous medium flows in a first flow direction V in the region of the nozzle 12 and/or of the mixing tube 18 and from there into the diffuser 20, the gaseous medium undergoing a change in direction in the transition region of the mixing tube 18 to the diffuser 20, with the result that the gaseous medium flows at least approximately in the second flow direction VI in the diffuser 20. In this case, the angle ß is greater than the angle α.

FIG. 2 shows that flow cross sections are formed in the inner flow region of the jet pump 4 which run, in particular, orthogonally to the respective flow direction V, VI, VII, VIII. In the region of the diffuser 20, the flow cross sections are designed, for example, as the at least one cross-sectional area A-A, wherein the at least one cross-sectional area A-A runs orthogonally to the second flow direction VI and/or the second longitudinal axis 40 of the diffuser 20. In this case, the cross-sectional area A-A increases in the second flow direction VI. In this case, there may be a reduction in the flow speed of the gaseous medium in the diffuser 20, in particular on account of the increasing cross-sectional area A-A. Moreover, the second flow direction VI and/or the second longitudinal axis 40 run/runs at least approximately linearly in the region of the diffuser 20 on account of the at least approximately linear profile of the first and second walls 17, 19, and therefore the gaseous medium also flows at least approximately linearly in the region of the diffuser 20.

After flowing through the diffuser 20, the gaseous medium flows into the outlet elbow 22 and from there into the connecting piece 26. Here, FIG. 2 shows that, in the region of the outlet elbow 22, a third wall 21 extends on that side of the outlet elbow 22 which is remote from the anode inlet 15. This third wall 21 can have an at least partially linear profile and/or at least partially have a curvature 23, it being possible, in particular, for the curvature 23 to have a radius. By means of the profile of the third wall 21, in particular as a curvature 23, the gaseous medium can be deflected toward the anode inlet 15 as it flows through the outlet elbow 22. In this case, the third longitudinal axis 42 of the outlet elbow 22 and/or the third flow direction VII of the gaseous medium in the region of the outlet elbow 22 run/runs at an angle γ to the first longitudinal axis 39 of the mixing tube 18 and toward the anode inlet 15. Here, the angle γ is, in particular, greater than the angle α and/or the angle ß.

As shown in FIG. 2, the gaseous medium undergoes a corresponding deflection as it flows through the diffuser 20 and/or the outlet elbow 22 and/or the connecting piece 26, being deflected from a first flow direction V, which runs at least approximately at right angles to the first flow path III and/or second flow path IV, into a fourth flow direction VIII, which runs at least approximately parallel to the respective flow path III, IV.

FIG. 3 shows a schematic sectional view of the conveyor unit 1 according to a second exemplary embodiment. In this case, part of the internal flow contour of the conveyor unit 1, in particular of a main body 13, is illustrated, the latter having the regions of intake region 7, mixing tube 18, diffuser 20 and connecting piece 26. The mixing tube 18, the diffuser 20, and the connecting piece 26 each have a respective longitudinal axis 39, 40, 44. The respective flow direction V, VI VIII VIII of the gaseous medium in this region runs along this respective longitudinal axis 39, 40, 44. In this case, the second longitudinal axis 40 of the diffuser 20 runs in an arc shape, with the result that the gaseous medium is deflected, in particular continuously, toward the anode inlet 15 as it flows through the diffuser 20.

The arc-shaped course of the second longitudinal axis 40 of the diffuser 20 results from the shaping of the walls 17, 19 of the flow region. In this case, a first wall 17 of the diffuser 20 has the curvature 23, and a second wall 19 of the diffuser 20, which is located opposite the first wall 17, has an at least approximately linear profile. Here, the second wall 19 runs at an angle ß to the first longitudinal axis 39 of the mixing tube 18. In a further exemplary embodiment, the second wall 19 can also have a curvature. As flow through the diffuser 20 progresses, the angle α between the curved second longitudinal axis 40 and the first longitudinal axis 39 increases from a value of at least approximately 0° to a value of at least approximately 90° toward the anode inlet 15. In this case, the second longitudinal axis 40 of the diffuser 20 runs in an arc shape in such a way that, in the initial region of the diffuser 20, it is at least approximately parallel to the first longitudinal axis 39 of the mixing tube 18, and, in the end region of the diffuser 20, it is at least approximately perpendicular to the first longitudinal axis 39 of the mixing tube 18, wherein, in particular, the opening of the end region of the diffuser 20 is directed toward the anode inlet 15.

FIG. 3 furthermore shows that the fourth longitudinal axis 44 of the connecting piece 26 runs parallel to the second flow path IV of the gaseous medium in the anode inlet 15, wherein the second longitudinal axis 40 of the diffuser 20 runs at least approximately parallel to the fourth longitudinal axis 44 of the connecting piece 26 in the end region of the diffuser 20.

FIG. 3 furthermore shows that flow cross sections are formed in the inner flow region of the jet pump 4 which run, in particular, orthogonally to the respective flow direction V, VI, VIII. In the region of the diffuser 20, the flow cross sections are designed, for example, as the at least one cross-sectional area A-A, wherein the at least one cross-sectional area A-A runs orthogonally to the second flow direction VI and/or the second, in particular arc-shaped, longitudinal axis 40 of the diffuser 20. In this case, the cross-sectional area A-A increases in the second flow direction VI. In this case, there may be a reduction in the flow speed of the gaseous medium in the diffuser 20, in particular on account of the increasing cross-sectional area A-A. Moreover, the second flow direction VI and/or the second longitudinal axis 40 run/runs at least approximately in an arc shape in the region of the diffuser 20, in particular on account of the curved profile of the first wall 17 and/or of the at least approximately linear profile of the second wall 19, and therefore the gaseous medium also flows at least approximately in an arc shape in the region of the diffuser 20, in particular toward the anode inlet 15.

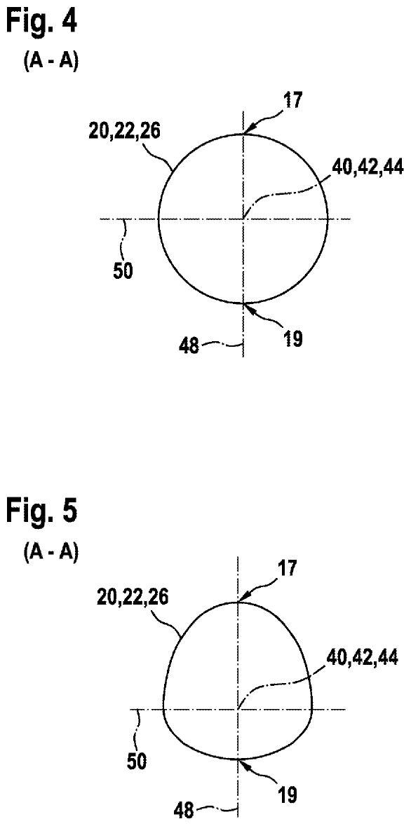

FIG. 4 shows a schematic sectional view of the at least one cross-sectional area A-A running orthogonally to flow direction VI in accordance with a first embodiment. In this case, the respective cross-sectional area A-A of the diffuser 20 has an at least approximately circular shape. A first reference axis 48 runs through the first wall 17, which, in particular at least in the initial region of the diffuser 20, runs away from the anode inlet 15, and the second wall 19 of the flow cross section. A second reference axis 50 runs orthogonally to this first reference axis 48. The second longitudinal axis 40 runs through the point of intersection of the two reference axes 48, 50 orthogonally to the two axes 48, 50 in a plane which is not illustrated.

FIG. 5 shows a schematic sectional view of the at least one cross-sectional area A-A running orthogonally to the second flow direction VI in accordance with a second embodiment. In this case, the respective cross-sectional area A-A has a rounded, in particular an ovoid and/or egg-shaped form. The first reference axis 48 runs through the first wall 17, which, in particular at least in the initial region of the diffuser 20, runs away from the anode inlet 15, and the second wall 19 of the flow cross section. In this case, the second reference axis 50 runs orthogonally to the first reference axis of the ovoid cross-sectional area in such a way that the latter is located in the region of the greatest distance between the walls of the flow cross section. The second longitudinal axis 40 runs through the point of intersection of the two reference axes 48, 50 orthogonally to the two axes 48, 50 in a plane which is not illustrated.

Optionally, the cross-sectional areas of the flow regions of the outlet elbow 22 and/or of the connecting piece 26 can also have a corresponding, at least approximately circular and/or ovoid shape.

From the first and second embodiments described in FIG. 4 and FIG. 5, it is possible to obtain the advantage that improved deflection of the gaseous medium is achieved as it flows through the diffuser 20, with which the frictional and/or flow losses are reduced, while the structural space required for the deflection of the gaseous medium to the anode inlet 15 can be reduced. Thus, the conveyor unit 1 and/or the jet pump 4 can also be installed in vehicles which have only a small installation space available. In this case, the flow transitions within the flow cross section of the jet pump 4 are designed to be optimized in terms of flow as far as possible, thus enabling turbulence and/or deceleration of the flow speed of the gaseous medium to be prevented.

Particularly in the second embodiment of the at least one cross-sectional area A-A, the majority of the gaseous medium to be conveyed can flow through the diffuser 20 in the second flow direction VI in the region of the second reference axis 50 and can thus undergo a greater deflection toward the anode inlet 15 since the second reference axis 50 is at a smaller distance from the second wall 19 and/or from the anode inlet 15, particularly in comparison with the first embodiment of the at least one cross-sectional area A-A, leading to improved flow behavior and a more compact design. Moreover, it is possible in this way to achieve improved flow guidance of the gaseous through the diffuser 20 and/or the overall conveyor unit 1.

Furthermore, depending on the embodiment of the conveyor unit 1 and/or of the jet pump 4, these shapes of the cross-sectional areas A shown in FIG. 4 or FIG. 5 can be used in any desired combination of the regions comprising the diffuser 20, the outlet elbow 22, the connecting piece 26 and the anode inlet 15 in the conveyor unit 1 according to the invention, but also in all other flow regions of the fuel cell system 31.

1. A conveyor unit (1) for a fuel cell system (31) for conveying and/or controlling a gaseous medium, the conveyor unit (1) having a jet pump (4), which is driven by a propulsion jet of a pressurized gaseous medium, and a metering valve (6), wherein an outlet of the conveyor unit (1) is fluidically connected to an anode inlet (15) of a fuel cell (29), wherein the jet pump (4) has an intake region (7), a mixing tube (18), and a diffuser (20), wherein the diffuser (20) is at least indirectly fluidically connected to the anode inlet (15) of the fuel cell (29), and wherein the gaseous medium flows through the jet pump (4) at least partly in a direction of a first flow direction V, which runs parallel to a longitudinal axis (39) of the mixing tube (18), characterized in that a longitudinal axis (40) of the diffuser (20) is curved or is inclined relative to the longitudinal axis (39) of the mixing tube (18).

2. The conveyor unit (1) as claimed in claim 1, characterized in that a first wall (17) of the diffuser (20) runs at least partially parallel to the longitudinal axis (39) of the mixing tube (18), and a second wall (19) of the diffuser (20), which is located opposite the first wall (17), runs at an angle (B) to the longitudinal axis (39) of the mixing tube (18), wherein the first wall (17) runs on a side of the diffuser (20) which is further away from the anode inlet (15), and the second wall (19) runs on a side of the diffuser (20) which is closer to the anode inlet (15).

3. The conveyor unit (1) as claimed in claim 1, characterized in that a first wall (17) of the diffuser (20) has a curved profile (23), and a second wall (19) of the diffuser (20), which is located opposite the first wall (17), has an at least approximately linear profile and runs at an angle (B) to the longitudinal axis (39) of the mixing tube (18).

4. The conveyor unit (1) as claimed in claim 2, characterized in that the longitudinal axis (40) of the diffuser (20) is inclined in a direction of the anode inlet (15).

5. The conveyor unit (1) as claimed in claim 3, characterized in that the longitudinal axis (40) of the diffuser (20) runs in an arc shape in such a way that, in the initial region of the diffuser (20), the longitudinal axis (40) of the diffuser (20) runs at least approximately parallel to the longitudinal axis (39) of the mixing tube (18), and, in an end region of the diffuser (20), the longitudinal axis (40) of the diffuser (20) runs at least approximately perpendicular to the longitudinal axis (39) of the mixing tube (18).

6. The conveyor unit (1) as claimed in claim 1, characterized in that a connecting piece (26) and/or an outlet elbow (22) are/is located between the diffuser (20) and the anode inlet (15) of the fuel cell (29) and connect/s the diffuser (20) and the anode inlet (15) of the fuel cell (29) at least indirectly fluidically to one another.

7. The conveyor unit (1) as claimed in claim 6, characterized in that a longitudinal axis (44) of the connecting piece (26) runs parallel to a second flow path IV of the gaseous medium in the anode inlet (15), wherein the longitudinal axis (40) of the diffuser (20) runs at least approximately parallel to the longitudinal axis (44) of the connecting piece (26) in an end region of the diffuser (20).

8. The conveyor unit (1) as claimed in claim 6, characterized in that the jet pump (4) has a heating element (11), wherein the jet pump (4) and/or the outlet elbow (22) and/or the connecting piece (26) are/is produced from a material or an alloy with a low specific heat capacity.

9. The conveyor unit (1) as claimed in claim 1, wherein the conveyor unit (1) comprises, as components, the jet pump (4), the metering valve (6) and/or a side-channel compressor (10) and/or a water separator (24), wherein the components of the conveyor unit (1) are positioned on an end plate (2) of the fuel cell (29) in such a way that flow lines between and/or within the components of the conveyor unit (1) run exclusively parallel to the end plate (2), wherein the end plate (2) is arranged between the fuel cell (29) and the conveyor unit (1).

10. A fuel cell system (31) having a conveyor unit (1) as claimed in claim 1.

11. The conveyor unit (1) as claimed in claim 3, characterized in that the longitudinal axis (40) of the diffuser (20) is inclined in a direction of the anode inlet (15).

12. The conveyor unit (1) as claimed in claim 1, wherein the longitudinal axis (40) of the diffuser (20) is curved relative to the longitudinal axis (39) of the mixing tube (18).

13. The conveyor unit (1) as claimed in claim 1, wherein the longitudinal axis (40) of the diffuser (20) is inclined relative to the longitudinal axis (39) of the mixing tube (18).
